(19) United States
(12) Patent Application Publication
(10) Pub. No.: US 2014/0083924 A1
(43) Pub. Date: Mar. 27, 2014

(54) FILTER UNIT AND A WATER FILTERING DEVICE COMPRISING A FILTER UNIT

(71) Applicants: Ulf Bergendal, Stockholm (SE); Paula Cherinet, Nacka (SE); Marco Coan, Stockholm (SE); Simon Faremo, Stockholm (SE); Anna-Karin Gray, Stockholm (SE); Tomas Hedlund, Vasterik (SE); Roger Karlsson, Stockholm (SE)

(72) Inventors: Ulf Bergendal, Stockholm (SE); Paula Cherinet, Nacka (SE); Marco Coan, Stockholm (SE); Simon Faremo, Stockholm (SE); Anna-Karin Gray, Stockholm (SE); Tomas Hedlund, Vasterik (SE); Roger Karlsson, Stockholm (SE)

(21) Appl. No.: 14/009,256

(22) PCT Filed: Apr. 1, 2011
(86) PCT No.: PCT/EP11/55120

§ 371 Date: Nov. 20, 2013

(51) Int. Cl. B01D 35/02

(52) U.S. Cl. CPC B01D 35/02
USPC 210/451; 210/435; 210/479

(57) ABSTRACT

The present invention relates to a filter unit (1) for use in a water filtering device (30). The filter unit comprises a housing (3) having an inlet (13a-d) for receiving water to be filtered and an outlet (25) for dispensing filtered water. A water filtering medium (5) is contained in between the inlet and outlet. The water filtering medium (5) comprises an ion exchange resin layer (5b) and an activated carbon loaded material layer (5c), which layers are provided as two distinct layers arranged in the housing. The invention further relates to a water filtering device, such as a water filter jug, comprising a filter unit.

### TECHNICAL FIELD

The present invention relates to a filter unit for filtration of water, for example for filtration of tap water for removing different contaminants in the water. More particularly, the invention relates to a gravity fed water filter unit providing filtration and thereby purification of the water. The filter unit is intended for use particularly but not exclusively in a household water filtering device, such as a water filter jug.

### BACKGROUND

Traditional gravity fed water filters are represented by a cartridge filled with a mixture of activated carbon grains and ion exchange resin with a consistency of sand or coffee grounds. The filter media provides removal of sediments, bad taste, i.e. chlorine taste, hardness and other contaminants such as metal ions and pesticides. Generally, the ion exchange resin reduces the hardness in the water caused by for example calcium and/or magnesium ions, while the activated carbon grains reduce the chlorine taste and/or smell.

A typical water filter cartridge has an elongated cylinder profile which is deep enough to allow pollutants to be absorbed by the filter media in the time it takes the water to flow through the filter cartridge. As the water flows through the filter media it takes the path of least resistance and makes its own channels through the filter cartridge. However, the thereby formed channels lead to that any impurities in the water to be treated may seep through the filter cartridge along with treated or purified water, since the water that flows through the channels does not contact the filter media for enough time to allow effective treatment to take place. Another drawback with this type of filter cartridge is the low filtration speed. A still further drawback is that small carbon particle from the mixture of activated carbon grains and ion exchange resin may follow the filtered water out through the filter cartridge outlet.

EP2277832A1 discloses a water filter jug that may be used with different kinds of filter cartridges. The water filter jug comprises a hopper which is capable of receiving different sized and/or shaped filter cartridges. The hopper includes a removable insert which reduces the effective area of the opening of the base in the hopper such that cartridges of different sizes may be fitted into the hopper.

In WO2004/052789A2 it is disclosed a filter cartridge for a standalone point of use water purification device, such as a water pitcher or jug. The filter cartridge contains a traditional filter media of ion exchange and activated carbon grains. However, in order to minimize channels in the filter media and thereby improve filtering, a first and second flow passageways containing flow through filter media and having opposed flow directions are arranged in the filter cartridge.

Even if the problem of channels in the filter media may have been minimized, the solution according to WO2004/052789A2 still suffers from a low filtration speed. Furthermore, a rather complicated filter is provided which probably leads to a higher filter cartridge cost.

Accordingly, as may be realized from the above, there is a need for improvements in the area of water filter units for domestic use.

### SUMMARY

An object with the present invention is to alleviate at least some of the drawbacks with the prior art water filter cartridges.

A further object with the present invention is to provide a filter unit for water filtration that provides filtrated and purified water within a short time, i.e. to provide a water filter unit with a high filtration speed.

Another object with the present invention is to provide a water filtration device comprising a filter unit which makes it possible to improve the ratio between the filtrated water volume and the total volume of the device, i.e. of the water filter jug.

At least one of the above objects are achieved by a filter unit for use in a water filtering device, which comprises a housing having an inlet for receiving water to be filtered and an outlet for dispensing filtered water. A water filtering medium is contained in between the inlet and outlet. The water filtering medium comprises an ion exchange resin layer and an activated carbon loaded material layer, which layers are provided as two distinct layers arranged in the housing.

By providing the ion exchange resin layer and the activated carbon loaded material layer as two separate and discrete layers in the filtering medium, a thin but yet effective filter unit may be obtained. The relatively thin configuration of the filter unit that is obtained by the two distinct layers of different filtering mediums results in a high filtration speed of the filter unit.

A further advantage with the relatively thin configuration of the filtering medium is that it is now possible to design the filter unit with a generally flat profile compared to the prior art cartridges having an elongated cylinder profile. The generally flat profile on the filter unit leads to that the hopper receiving the filter unit may be minimised which in turn leads to an improved ratio between the filtrated water volume and the total volume of the device, i.e. of the water filter jug.

As a result, at least one of the above mentioned objects are achieved.

According to an embodiment, the ion exchange resin layer is provided on top of the activated carbon loaded material layer. Further, a layer of a non-woven material is provided below the activated carbon loaded material layer.

In a start up phase of using a filter unit, for example when a filter unit is new, a first amount of water that passes through an ion exchange layer will show a drop in the pH-value of the filtered water. Therefore, in some prior art filter cartridges it is advised that the first litres of water filtered through a new filter cartridge should be discarded until the pH-value has stabilised and the filter cartridge is saturated with water. In the present invention, the activated carbon loaded material is arranged below, i.e. after the ion exchange resin layer. The activated carbon loaded material naturally has a certain alkaline contribution to the water being filtered. In a start up of a new filter unit the pH-value will drop slightly at the passage of the ion exchange layer but will then rise again up to acceptable levels after passage of the activated carbon loaded material layer. Accordingly, it is at all times possible to drink the water filtered by the filter unit in accordance with the herein disclosed embodiment.

According to another embodiment, the housing of the filter unit comprises a cover provided with at least one inlet opening forming the inlet of the housing. Furthermore, the cover is provided with at least two sections over its surface, which sections are arranged to incline towards the outer periphery of the cover.

The surface of the cover inclines in a stepwise manner against the peripheries of the cover. In this way, water flows over the cover and is distributed evenly over the cover. An improved distribution of water on the cover provides for a good distribution of the water over the filter medium arranged below the cover. This in turn results in an efficient use of the whole filtering medium arranged below the cover.

According to an embodiment, the cover comprises a first section in the form of an elevation arranged centrally on the cover, which elevation has an inclined edge arranged to distribute water to the peripheries of the cover. The inclined edge of the elevation in the cover is provided with a plurality of inlet openings. Also, the cover comprises a second section in the form of an intermediate section surrounding the elevation, which intermediate section is provided with a plurality of inlet openings.

In this way, water to be filtrated may percolate through the openings in the cover surface as the water is transported out towards the peripheries of the cover by means of the stepwise inclined cover surface. By continuously distributing the water over the whole surface of the cover the risk of forming channels in the ion exchange resin layer is reduced.

According to an embodiment, the housing of the filter unit comprises a bottom provided with openings forming the outlet from the housing. Further, the inlet of the housing is arranged above the outlet of the housing such that water to be filtrated may pass the filtering medium through gravity force.

In a further aspect, at least one of the above mentioned objects are achieved by a water filtering device comprising a filter unit for example according to the above described embodiments. The water filtering device comprises a container adapted hold filtered water, a hopper adapted to be mounted in the container and to hold unfiltered water. The filter unit is adapted to be mounted in the hopper for filtering water introduced into the hopper. The filter unit provides an outlet from the hopper through which filtered water reaches the container, wherein the filter unit constitutes the bottom of the hopper such that filtration of water takes place through the whole bottom area of the hopper.

The generally flat and extended shape of the filter unit constituting the bottom in the hopper makes it possible to provide a water filtering device with a high ratio of the filtered water volume compared to the overall volume of the water filtering device in relation to other known devices. Accordingly, the hopper may be designed to take less space in the container compared to prior art water filter jugs. Further, a large inlet area for the water to contact the filter also contributes to an improved filtration speed.

According to an embodiment, the cover and the bottom of the filter unit has substantially the same areas as the bottom area of the hopper. In this way the area provided with inlet openings is substantially equal to the area provided with outlet openings. This constructional feature of the filter unit and hopper will facilitate output from the filter unit which therefore contributes to an improved, i.e. high filtration speed.

According to an embodiment, the water filtering device comprises a lid provided with a rocker which is arranged to allow water into the hopper through an opening in the lid. Further, the rocker is resiliently arranged to the lid at the opening. Furthermore, the rocker may pivot downwards from the opening into the hopper such that an angle up to about 25 degrees is formed between the lid and the rocker.

When an inlet water stream hits the rocker, the rocker pivots down into the opening in the lid to allow the water into the hopper. The stream of water is thereby dispersed and decelerated as it hits the rocker. A dispersed inlet water stream minimizes the risk of channels in the filtering medium below the cover of the filter unit.

Further features of, and advantages with, the present invention will become apparent when studying the appended claims and the following description. Those skilled in the art realize that different features of the present invention may be combined to create embodiments other than those described in the following, without departing from the scope of the present invention, as defined by the appended claims.

### BRIEF DESCRIPTION OF THE DRAWINGS

The various aspects of the invention, including its particular features and advantages, will be readily understood from the following detailed description and the accompanying drawings, in which:

FIG. 1 is a perspective view of a water filter unit according to an embodiment,

FIG. 2 is a bottom view of the filter unit in FIG. 1,

FIG. 3 is a side view of the filter unit in FIG. 1,

FIG. 4 is a schematic view of a cross-section of the filter unit along the line A-A of FIG. 3 showing the discrete layers of the filtering medium inside the filter unit,

FIG. 5 illustrates a water filtering device according to an embodiment into which a filter unit of FIG. 1 may be provided, and

FIG. 6 shows a cross-sectional view of a water filtering device according to FIG. 5.

### DETAILED DESCRIPTION OF PREFERRED EMBODIMENTS

The present invention now will be described more fully with reference to the accompanying drawings, in which example embodiments are shown. However, this invention should not be construed as limited to the embodiments set forth herein. Disclosed features of example embodiments may be combined as readily understood by one of ordinary skill in the art to which this invention belongs. Throughout the following description similar reference numerals have been used to denote similar elements, parts, items or features, when applicable.

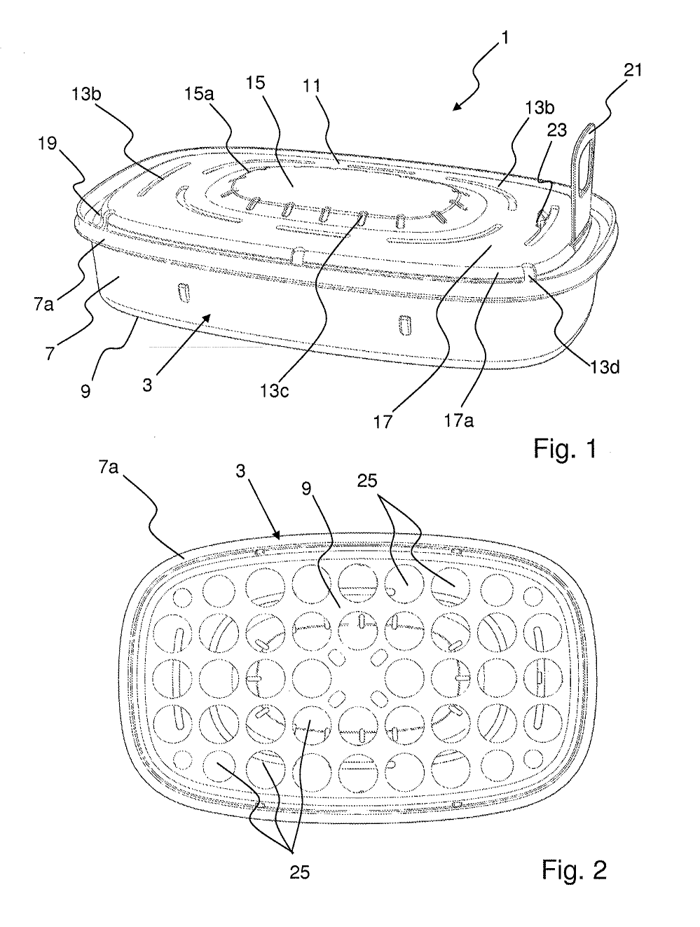

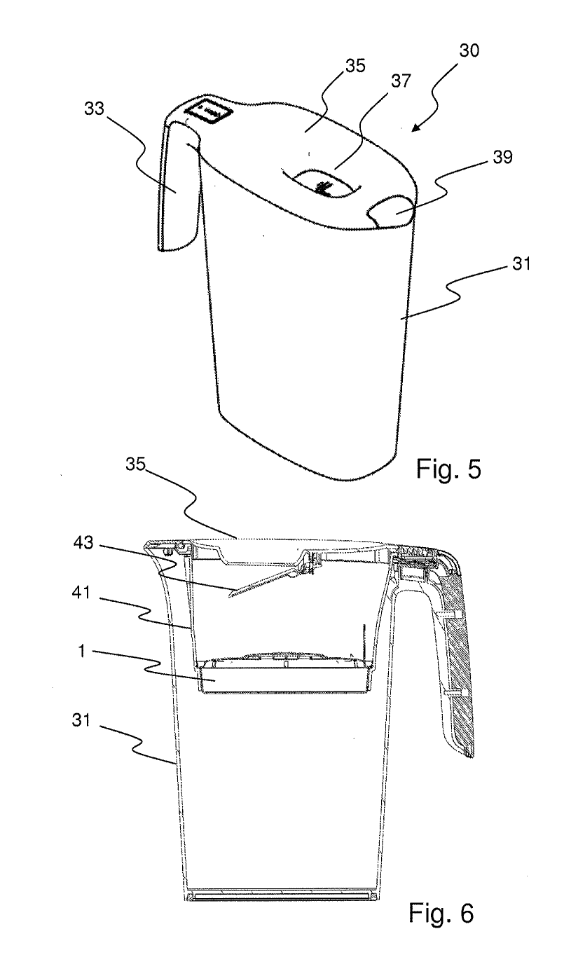

In FIG. 1 a water filter unit 1 according to an embodiment is illustrated. The filter unit comprises a housing 3 holding a filter medium (not shown). The housing of the filter unit has a generally flat rectangular shape with a side wall 7, a bottom 9 and a cover 11. The filter unit is intended to be used in a water filtering device, for example in a water filter jug. An embodiment of such a water filtering device 30 is illustrated in FIGS. 5 and 6. In use, water is poured into the water filtering device and passes through a water filter unit provided in the device whereby filtered and purified water is collected in the bottom of the water filtering device. A hopper is provided in the container for receiving unfiltered water and into which the filter unit is installed.

The housing of the filter unit 1 will hereinafter be described in relation to FIGS. 1-3. The side wall 7 is connected to the bottom 9 such that the housing may receive the filter medium. A cover is provided as a lid or top to close the housing. The cover 11 is connected to a rim portion 7a on the side wall 7. The rim portion 7a projects out from side wall at approximately a right angle. The rim portion 7a seals against the inner walls of the hopper when the filter unit is installed in the water filtering device. The cover 11 of the housing 3 has several openings 13a, 13b, 13c, 13d in its surface providing an inlet of the housing, such that water may flow into the housing where the filtering medium is provided. The cover 11 of the housing 3 is adapted to distribute the water over the surface of the cover. The openings have different forms and arranged over the surface of the cover. The openings may be provided as straight 13a or curved slots 13b. They may also be provided as circular, oval or rectangular openings 13c, 13d. The differently shaped and sized openings are arranged in a pattern for optimizing the distribution of water over the cover surface.

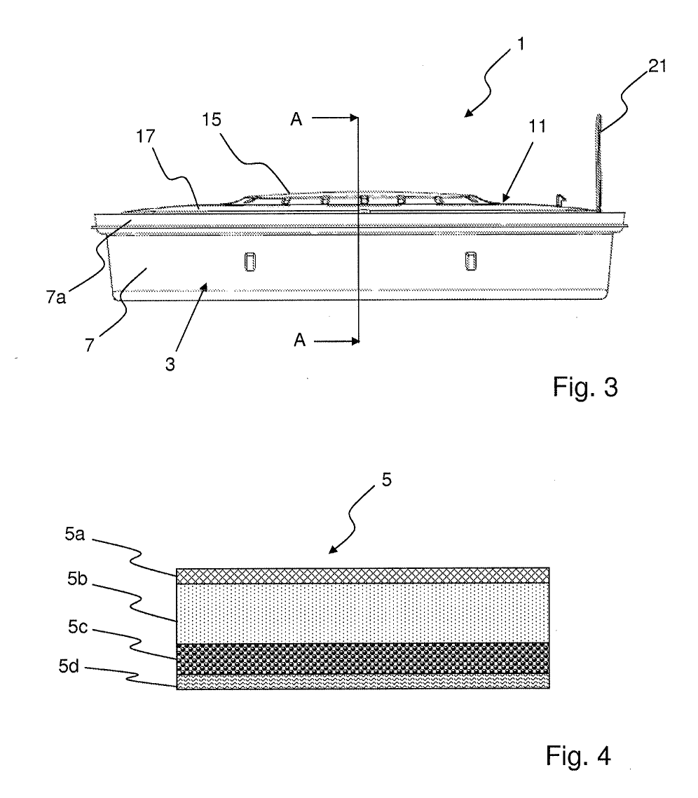

The cover 11 may be divided into different sections or levels. In the shown embodiment in FIGS. 1 and 3 the cover surface has three different levels. The first level is a plateau-shaped portion or elevation 15. The elevation may be positioned centrally on the cover surface. The elevation has inclined edges 15a such that water flows down from the elevation to enhance the water to reach the peripheries of the cover surface. The second level is an intermediate section 17 situated slightly below the elevation 15. The intermediate section 17 has inclined edges 17a such that water continuous to flow towards the peripheries of the cover 11. The third level has the form of a ditch 19 provided at the periphery of the cover. The periphery of the ditch 19 is confined by the rim portion 7a. In this way a continuous flow of water is obtained over the cover. The water is distributed out towards the inlet openings 13a-d provided on the cover 11.

The surface shape of the cover 11 with its inlet openings 3a-d has the function of distributing the water over the surface of the cover and to the underlying filtering medium through the inlet to the housing formed by the openings 13a-d. Further, the elevation 15 has a further function of allowing air bubbles formed and/or trapped in the filtering medium to escape. By the provision of the elevation 15 a space is formed between the filtering medium and the cover. Air bubbles may leave the filtering medium into the space formed under the elevations. Air bubbles may then escape through openings 13c in the inclined edge 15a of the elevation 15.

A ring-shaped grip 21 is provided on the cover 11 of the housing 3. The ring-shaped grip may be used for facilitate the removal of the water filter unit when it is time to change it for a new one. During transport and/or packaging the ring-shaped grip 21 is folded down against the cover surface. The ring-shaped grip may be locked in the folded down position by a snap fit engagement with a peg 23 protruding from the surface of the cover. The ring-shaped grip 21 is connected to the cover 11 of the housing 3 via a living hinge.

FIG. 2 shows a bottom view of the water filter unit. The bottom 9 comprises a bottom plate designed to let as much water as possible pass out through the filter unit. The bottom is provided with openings 25 provide an outlet from the housing. The openings 25 may be circular or oval in shape. However, other shapes are also possible. A plurality of openings may be provided such that the output of filtered water is not hindered. The openings 25 may represent more than 50% of the total area of the bottom 9. In the illustrated embodiment the housing is empty and therefore the cover 11 with its inlet openings 13a-d is visible through the bottom. The pattern of the inlet openings 13a-d focuses on distribution of water over the entire surface of the cover 11. The plurality of outlet openings 25 that are arranged closely to each other focus on an efficient outflow rate of filtered water. The result is a water filter unit with a high filtration speed.

In FIG. 4 the filtering medium 5 is schematically illustrated in an enlarged scale according to a cross-section along A-A in FIG. 3. It should be noted that the cover and the bottom of the housing have been left out in the schematic FIG. 4. Directly under the surface of the cover 11 of the housing a mesh net 5a is arranged. The mesh net is positioned over an ion exchange layer 5b. The particles in the ion exchange layer may be smaller than the openings in the housing of the filter unit. During transport and before being put into use, the ion exchange layer is in a dry and particulate form. The mesh net keeps the small particles in the ion exchange layer in place and prevents any particles from leaving the housing through the inlet openings in the cover. Below the ion exchange layer 5b is provided a loaded activated carbon material layer 5c. The loaded activated carbon layer is a polyester sheet impregnated with activated carbon. Below activated carbon layer is provided a non-woven layer 5d.

FIG. 5 illustrates a water filtering device 30 according to an embodiment into which a filter unit 1 of FIG. 1 may be provided. The device 30 comprises a container 31 for holding filtered water. The container is provided with a handle 33 and may be covered by a lid 35. The lid has an inlet opening 37 for pouring water to be filtered into the container 31. The lid is further provided with a spout opening 39 such that filtered water may be poured out from the container without removing the lid.

In FIG. 6 the water filtering device is shown in cross-section. A hopper 41 is arranged in the container 31. The hopper holds the water filter unit 1 in a detachable manner. The filter unit constitutes the bottom in the hopper. Therefore, filtration may take place over the whole bottom area of the hopper. Water to be filtered and purified is poured through the inlet opening 37 in the lid 35 and is received in the hopper. The inlet opening in the lid is provided with a rocker 43. The rocker is resiliently arranged in the opening in the lid. When water is poured into the inlet and thus onto the rocker 43, the rocker pivots down to let the water in to the hopper 41. When the water stream hits the rocker, the rocker forms an angle of about 20-25 degrees with respect to the lid. The stream of water is thereby dispersed as it hits the rocker 43. The water is distributed over the surface of the cover of the water filter unit 1. The water percolates into the filter medium inside the housing. The water passes through the filter medium and falls down into the container 31.

1. A filter unit for use in a water filtering device, the filter unit comprising:
a housing having an inlet for receiving water to be filtered and an outlet for dispensing filtered water; and
a water filtering medium contained between the inlet and the outlet, the water filtering medium comprising an ion exchange resin layer and an activated carbon loaded material layer, and wherein the ion exchange resin layer and the activated carbon loaded material layer comprise two distinct layers arranged in the housing.

2. A filter unit according to claim 1, wherein the ion exchange resin layer is provided on top of the activated carbon loaded material layer.

3. A filter unit according to claim 1, wherein a layer of a non-woven material is provided below the activated carbon loaded material layer.

4. A filter unit according to claim 1, wherein the housing of the filter unit comprises a cover provided with at least one inlet opening forming the inlet of the housing.

5. A filter unit according to claim 4, wherein the cover is provided with at least two sections, which sections are arranged to incline towards an outer periphery of the cover.

6. A filter unit according to claim 4, wherein the cover comprises a first section in the form of an elevation arranged centrally on the cover, which elevation has an inclined edge arranged to distribute water to the an outer periphery of the cover.

7. A filter unit according to claim 6, wherein the inclined edge of the elevation is provided with a plurality of inclined edge inlet openings.

8. A filter unit according to claim 6, wherein the cover comprises a second section in the form of an intermediate section surrounding the elevation, which intermediate section is provided with a plurality of intermediate section inlet openings.

9. A filter unit according to claim 1, wherein the housing of the filter unit comprises a bottom provided with openings forming the outlet from the housing.

10. A filter unit according to claim 1, wherein the inlet of the housing is arranged above the outlet of the housing such that water to be filtrated may pass the filtering medium through gravity force.

11. A water filtering device comprising:
a container adapted hold filtered water,
a hopper adapted to be mounted in the container and to receive unfiltered water; and
a filter unit adapted to be mounted in the hopper for filtering water introduced into the hopper, the filter unit providing an outlet from the hopper through which filtered water reaches the container;
wherein the filter unit occupies a whole bottom area of the hopper when the filter unit is mounted in the hopper, such that filtration of water takes place through the whole bottom area of the hopper.

12. A water filtering device according to claim 11, wherein the filter unit comprises a housing having an inlet for receiving water to be filtered and an outlet for dispensing filtered water, wherein a water filtering medium is contained in between the inlet and outlet, the water filtering medium comprising an ion exchange resin layer and an activated carbon loaded material layer, and wherein the ion exchange resin layer and the activated carbon loaded material layer comprise two distinct layers arranged in the housing.

13. A water filtering device according to claim 12, wherein the housing comprises a cover provided with at least one inlet opening forming the inlet of the housing and a bottom provided with openings forming the outlet from the housing, wherein the cover and the bottom of the filter unit has substantially the same areas as the bottom area of the hopper.

14. A water filtering device according to claim 11, wherein the device comprises a lid provided with a rocker which is arranged to allow water into the hopper through an opening in the lid, and wherein the rocker is resiliently arranged to the lid at the opening.

15. A water filtering device according to claim 14, wherein the rocker is configured to pivot downwards from the opening into the hopper such that an angle up to about 25 degrees is formed between the lid and the rocker.

16. A filter unit according to claim 2, wherein a layer of a non-woven material is provided below the activated carbon loaded material layer.

17. A filter unit according to claim 7, wherein the cover comprises a second section in the form of an intermediate section surrounding the elevation, which intermediate section is provided with a plurality of intermediate section inlet openings.
